(19) United States
(12) Patent Application Publication
(10) Pub. No.: US 2008/0140525 A1
(43) Pub. Date: Jun. 12, 2008

(54) Method For Targeting Control Of Online Advertising And Associated Method And System

(75) Inventors: Rene Klaus Lamsfuss, Karlsdorf (DE); Hansjoerg Kern, Karlsruhe (DE); Matthias Ehrlich, Karlsruhe (DE)

Correspondence Address: Davidson, Davidson & Kappel, LLC, 485 7th Avenue, 14th Floor, New York, NY, 10018, US

(73) Assignee: 1 & 1 Internet AG, Montabaur (DE)

(21) Appl. No.: 11/664,239

(22) PCT Filed: Sep. 27, 2005
(86) PCT No.: PCT/EP05/10434

§ 371 Date: Oct. 9, 2007

Related U.S. Application Data
(60) Provisional application No. 60/614,339, filed on Sep. 29, 2004.

(30) Foreign Application Priority Data
Sep. 29, 2004 (DE) 10 2004 047 815.5
Sep. 20, 2005 (DE) 10 2005 044 936.0

(51) Int. Cl. G06Q 30/00; H04L 29/08

(52) U.S. Cl. 705/14

(57) ABSTRACT

A method, a device and a system are proposed for controlling advertising in an information network, in particular the Worldwide Web (WWW), via which several users have access to information. The system has a data-processing device formed as a profiler which allocates a user identity to every user and which evaluates first data which a first device provides and which contains details about his access behaviour to the information, in particular logfile data. The profiler also evaluates for the respective users second data which a second device provides and which contains details about the users' interests in the type of information which is preferably gathered via questionnaires online and/or offline. The profiler supplements the first and/or second data with third data which a third device provides and which contains details about the identity of the respective user. These personal data come from a service provider system such as e.g. the freemail system www.freemail.de. The profiler extracts control data for the respective user from the data and transmits these to a control device for controlling the advertising, in particular to an adserver.

### TECHNICAL FIELD OF THE INVENTION

In general, the invention relates to the targeting of online advertising in an information network. In particular the invention relates to a method, a device and a system for controlling and displaying ad banners on the internet, in particular on webpages and in internet-supported application programs, such as e.g. browsers and communication programs (e-mail, instant messaging, chat or internet telephony). Furthermore the invention relates in particular to the targeting of online advertising on the internet by means of extending the reach of online advertising from a first internet platform to a second, larger internet platform.

### TECHNICAL BACKGROUND OF THE INVENTION

The internet, too, is being increasingly used for advertising. This so-called online advertising has the advantage, compared with advertising via the classic media such as print media (newspapers and magazines) and radio and television, that techniques can be used there for targeting advertising. Thus e.g. advertising spaces, so-called ad banners (or “ad” for short) of different sizes are displayed, wherein these can be displayed to the internet user via his browser temporarily or also permanently for a session etc. A banner appears e.g. as a so-called pop-up window during a visit to a website/webpage or as so-called banners within a website/webpage. Various techniques and programs for the design and control of banners have already been known for some time, such as, say, Flash® from Macromedia or the “Adware” freeware etc. Internet advertising operates, say, via portals such as e.g. on that of the applicant, which can be visited under the URL http://www.web.de. Other forms of advertising are i.a. the incorporation of banners in internet application programs and online services, in particular in the freeware sector. There may be named here e.g. the freeware version of the Opera browser (see. http://www.opera.com) or the freemail service provided by the applicant (http://www.freemail.de).

A targeting of advertising has the advantage that the potential customers at whom advertisements are aimed receive as much as possible those very advertisements which appeal to them directly and are felt by them to be pleasant. An advertisement which is tiresome and which is felt to be disruptive completely fails in the aim of persuading customers to buy the advertised goods or services. In recent years it has become increasingly recognized that it is indeed the internet that is very suitable for targeted advertising. The internet offers an asynchronous upstream channel from the client of the internet user to the server of the advertiser, so that user behaviour can be recorded and analyzed for the control of advertising. Specially configured computers are used which record and evaluate various online data, such as, e.g. using the top level domain, the country from which the internet user is surfing, the current date and the local time etc. A so-called adserver controls one or more so-called contentservers and supplies appropriate advertising content in different formats to them. The internet advertising can thus be intelligently controlled on the basis of the evaluated online data. The term “to control” is to be understood very generally here and also includes the provision and/or supply of the respective advertising form (e.g. banner). The control device (here: the adserver) is thus also a device for providing and/or supplying the form of advertising to the contentserver(s). The adserver preferably provides supply in response to a request by the respective contentserver. For example the advertising can be connected up-to-date and in the respective natural language of the country. Many further forms of targeted advertising (so-called targeting) are possible. The adserver is the executive control device. The basic functions of adservers are described e.g. in the internet encyclopaedia Wikipedia under the following URL: http://de.wikipedia.org/wiki/Adserver.

As the known systems equipped with adservers usually evaluate only the online data obtained via the upstream channel, they can vary the control of internet advertising to only a limited extent, namely only to the extent of the resulting changes in these online data. However it would be desirable to have a method and a system which could make possible a control of advertising that is clearly more flexible and offers more variation. Moreover, the evaluated online data predominantly relate to technical parameters, such as, say, domain, date and time, and less to personal data of the respective internet user. For this reason also, the conventional targeting of advertising is very limited. It would also be desirable to have a method and system for controlling advertising which can be used not only on the internet in the narrower sense (thus in the so-called Worldwide Web), but also in other information networks, such as, say, in telecommunication networks (PSTN, GSM, UMTS) or in cable and satellite networks with upstream channels etc. This is true above all against the background that the conventional network technologies are increasingly merging together into a single global information and communication network.

### OBJECT OF THE INVENTION

It is therefore the object of the invention to propose a method for controlling advertising in an information network which overcomes the above-named disadvantages in advantageous manner. A system carrying out the method is also to be proposed.

### DESCRIPTION OF THE INVENTION

The object is achieved by a method having the features of claim 1 and by a device or a system for carrying out the method with the features of the coordinated claim.

Accordingly a method for controlling advertising in an information network over which several users have access to information is proposed, in which a user identity is allocated to every user and for every user first data are recorded which contain details of his access behaviour to the information. The user identity is allocated to the user anonymously, i.e. the system manages and processes the recorded data merely under an identity in the form of an anonymous code without specific reference to the identity of the user. Second data are also recorded for the respective user which contain details about his interest in the type of information. Then the first and/or second data are supplemented by third data which contain details about the identity of the respective user. These details are thus personal data, i.e. person-specific features such as e.g. age or sex. Thereafter, control data are extracted from the data for the respective user and transmitted to a controlling device to control the advertising.

A device and a system for controlling advertisements in the information network are also proposed. The system comprises several system components, namely a data-processing device which assigns a user identity to every user and which evaluates the first data a first device provides and which contain details about his access behaviour. The data-processing device also evaluates second data for the second user which a second device provides and which contain details about the interest of the user in the type of information, wherein the data-processing device supplements the first and/or second data by third data which a third device provides and which contain details about the identity of the respective user. The data-processing device also extracts control data from the data for the respective user and transmits these to a control device for controlling the advertising.

Advertising control with a very high strike rate is achieved through this combination and evaluation of different types of data from several data sources. Thus access can also be gained to data which conventionally are already recorded for other purposes or are gathered for specific services.

In this context firstly the first data are to be named which contain details about the access behaviour of the respective user. These are in particular online data which are essentially recorded by so-called log writers in the form of log files, in order usually to monitor access to computers, such as e.g. end-user PCs. The data from the log files contain details such as e.g. the IP addresses of the accessing computers and the access times. So-called cookies can also be used. All these details allow direct conclusions as to the computer's access behaviour and at least indirect conclusions as to the actual user behaviour.

According to the invention these data are now evaluated as first data for controlling advertising. The IP address in the system need not be utilized and/or stored, which is advantageous in respect of data protection. However, second data are also used which are recorded by polling users. These are essentially poll data about users' interests. They are thus details about the topics and areas of interest preferred by the respective user, for which a high level of acceptance may be expected from the user, if he is to be provided with the latest information and thus also advertising relating to same. These second data can preferably be gathered by online polling. Other possibilities would be data gathering through surveys by letter post and/or e-mail. The combination of the first data (online data, log files) with the second data (poll data) alone already offers a new and very broad database for a particularly accurate evaluation. Thus e.g. a connection can already be recognized as to when (season, time of day etc.) the user is interested in which subjects. For example, in the spring a user may be particularly interested in travel and holidays, but in the winter in shopping and visits to restaurants. The IP address can also possibly be recorded in order to check whether the user is located in the Earth's northern or southern hemisphere. The evaluation of these data means that the user can have targeted advertising addressed to him.

However, the invention goes one stage further and, during the control of the advertising, also takes account of the named third data which contain details about the identity of the user, i.e. personal details such as, say, the age and sex of the user. Such data are usually recorded by service providers for the purpose of user administration, in particular for billing. In this context an e-mail service is to be named as a typical service, such as that also offered by the applicant under the URL http://freemail.de. These personal data (such as e.g. age or sex) are gathered by the service provider offline and/or requested online during registration. It was not previously known to also evaluate this type of data for the purpose of controlling advertising and to combine it with further details (first and/or second data) recorded online and/or offline. The invention is based on the recognition that these data also represent sociodemographic facts with whose help target-oriented advertising can be greatly improved if these data are also allowed to feature in the evaluation of the previously named first and/or second data (online access data and/or poll data).

An automatic active method and a system operating according to it are proposed here which supply new and high-quality control data which e.g. can be used by an adserver. The personal data are not processed under the generic user passwords which a user management (e.g. the user management of an e-mail service) uses, but under a user identity (UID) which is generated by the system proposed here specifically for the purpose of controlling of advertising, is generated preferably by random generator as anonymous code, in order to prevent the data from being traced back to individuals. This anonymous code is stored e.g. in the form of a cookie on the user's PC, via which the user accesses the information network. Upon a later access by the user the anonymous code and the user profile allocated to it are recognized and used for targeting of the advertisement.

Additionally, according to the invention at least the control data extracted for every user will be stored in a user profile under the allocated user identity. There is a particular advantage in this connection if the extracted control data are used anonymized, the control data being managed in each case for every user under the relevant user identity, but without reference to the name of the individual.

Further advantages result from the dependent claims:

It is advantageous if in addition the prepared user profiles are also compared with each other and their completeness and commonality of data checked by means of predeterminable testing criteria. In this context a particular advantage results if an incomplete user profile which has a sufficient commonality, determined by the testing criteria, with another user profile is completed by means of the data of the other user profile.

It is also advantageous if group data are extracted from the user profiles and combined into a group profile, wherein the user identities allocated to the users are discarded. The individual user profile itself is preferably not discarded, but retained.

In other words: A user identity is allocated to every user and for every user first data are recorded which contain details about his access behaviour to the information. These first data are preferably so-called log file data. The user identity is allocated to the user anonymously, i.e. the recorded data are managed and processed there merely under an identity in the form of an anonymous code without specific reference to the identity of the user. Second data are also recorded for the respective user which contain details about his interest in the type of information. These second data are preferably data which are ascertained from a user poll. Then the first and/or second data are supplemented by third data which contain details about the identity of the respective user. These details are thus personal data, i.e. person-specific features such as e.g. age or sex. Control data are then ascertained from the data for the respective user and transmitted to a control device to control the advertising.

Advertising control with a very high strike rate very is achieved through this combination and evaluation of different types of data from several data sources proposed here. Access is thus possible to data which usually are already recorded for other purposes or are gathered for specific services. In this context in particular the combination of the first data, which come from the so-called log files and e.g. give the IP addresses of the accessing computer and the access times, are to be named with the third data, which are user data from another application and e.g. come from the user database of an e-mail provider.

Even if the reach of online advertising is clearly increased by these measures, it would be desirable to also have further specifically configured embodiments of the invention with which the reach can be yet further increased or extended. This is also to be achieved to a particular extent in that, starting from a first internet platform, the online advertising is extended to at least one further internet platform which has a greater potential reach.

Therefore, the method according to the invention is preferably developed to extend the reach of online advertising from a first internet platform which has a first usership with a first reach onto a second internet platform which has a second usership with a second, larger reach, the method comprising the following steps:

first and/or second data are recorded for the first usership which contain details about users' access behaviour or details about users' interests with regard to online information, and third data are recorded which contain personal details about the respective users;

first control data for online advertising on the first internet platform are ascertained from these data recorded for the first usership;

a first advertising volume achieved by this online advertising on the first internet platform is ascertained and compared with a planned advertising volume;

if the first advertising volume is smaller than the planned advertising volume, second control data for online advertising on the second internet platform are ascertained from the first and/or second control data recorded for the first usership, wherein the third data which contain personal details about the respective users are recorded also for the second usership, and wherein profiles are ascertained for both userships which give the commonalities and/or differences in order to gear the online advertising on the second internet platform to the profile of the first usership.

Thus the reach of a probably too small media offer (first platform) can be transparently extended onto at least a further media offer (second platform etc.) with a greater reach. “Transparently” means in this context that the online advertising on the first media offer attracts a specific target group and is now permeably extended for this target group onto a larger media offer. For example an advertisement for young females or young adults in the 13-19 age group is directed on a first media offer to a well-known youth magazine and the corresponding internet website www.bravo.de. The website delivers several hundred thousand female users who belong to this target group. However, it is wished to clearly extend the reach. With the help of the present invention, the advertising can be extended to another media offer, e.g. to the website of a large online portal www.web.de, for the same target group so that several million female users are reached. The reach is extended convergently so that both media offers virtually merge to form a large media offer. Any overlap between the userships and redundancies which may result from this can be avoided. Thus the same users are not equally canvassed on both media offers without the possibility of added value, because in fact the extension of reach according to the invention analyzes the userships of the media offers and prepares profiles for same and matches these. Therefore this transparent and convergent extension of reach is particularly interesting for applications in the field of cross-media marketing in which the same goods and/or services are to be marketed simultaneously on more than one different media offers.

This particular embodiment of the invention is also illustrated in even more detail in the following description of embodiment examples according to the invention.

For better understanding, some of the terms used here will be explained beforehand: By internet platform is meant here any type of internet-supported media offer or online offer, in particular websites or web presences. Therefore the umbrella term “offer” is also used below.

A target group is a set, precisely defined to a greater or lesser extent, of market participants at whom such an offer with its advertised goods and services is directed. A target group is defined in particular with reference to sociodemographic features (such as e.g. age, marital status, disposable household income, geographical area etc.), but can also take into account psychographic features (such as e.g. attitudes and values with the resulting consumer behaviour, preferences, awareness of status, frankness, aesthetic sensitivity etc.).

By reach is meant the numbers in a target group that is reached by the help of marketing. It is a measure of the spread or penetration of the respective advertisement within the addressed target group. In online marketing e.g. so-called adimpressions or adviews are ascertained criteria for effective reach. So-called pageimpressions or pageviews can also be ascertained.

Adimpressions, AI for short, are measured if a user is presented with a banner while he is on a website. This is then called a visual contact, i.e. an adview. The strength of a campaign is measured by the number of such adviews which are connected by an adserver according to specific criteria. More adviews can be connected in a specific period of time in higher-capacity media than in others.

Pageimpressions, PI for short, is the term used when there is visual contact between a user and a site/page on the internet. Using the principle of links, further PIs can be carried out in respect of other sites, wherein the browser provides the optical frame for this visual contact. The relationship between PI and AI represents an interesting measurement of the conduct of an advertising campaign. Ideally, an AI will accompany a PI, meaning that each time a user visits a site/page he is shown an ad banner simultaneously.

### DESCRIPTION OF THE FIGURES

The invention and the advantages resulting from it are now described in more detail using the accompanying drawings. The drawings reproduce the following schematic representations:

FIG. 1 shows the basic structure of an information network in the form of the Worldwide web, into which the system according to the invention is integrated;

FIG. 2 shows an application of an internet service in the form of the user interface of an e-mail service in which an ad banner is inset according to the method according to the invention;

FIG. 3 shows in the form of a block diagram the structure of a system for carrying out the method;

FIG. 4 shows in the form of a table an exemplary data acquisition with the data evaluated by the method;

FIG. 5 shows in the form of a flowchart the sequence of the method;

FIG. 6 shows a special embodiment example relating to the extension of reach in the form of a schematic representation of an arrangement of two systems for controlling online advertising on two internet platforms and an intermediate device (communication unit) for extending the reach from the smaller to the larger platform;

FIG. 7 shows in the form of a flowchart the sequence of the method for extending the reach;

FIGS. 8a/b show this arrangement or the sequence of this method in an alternative form of representation; and

FIG. 9 shows in more detail the structure of a preferred variant for the system for controlling online advertising.

### DESCRIPTION OF PREFERRED EMBODIMENT EXAMPLES

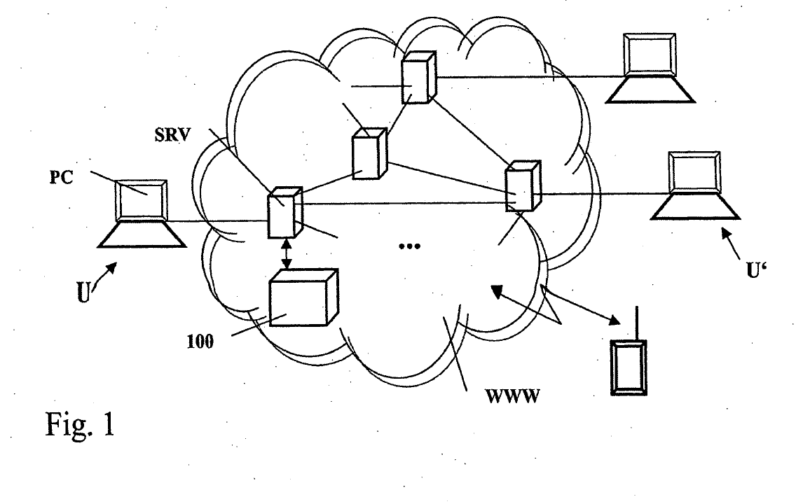

There is shown schematically in FIG. 1 the structure of an information network WWW which here has the form of the hypermedia system the “Worldwide Web” established in the internet. A standardized surface for presenting information and interfaces for various internet services is made available on the WWW. The WWW is the most popular information-access medium due to its user-friendliness and its multimedia capability.

Represented by way of example in FIG. 1 are two users U and U′ who are surfing the WWW via their respective PCs using the browser and requesting the information of interest to them there. Mobile terminals with a browser function can also be used. The WWW offers by way of information a large number of linked documents in the form of HTML pages. The hyperlinks make links between the information documents possible. These are pointers which are incorporated into the HTML pages. For example, text documents, graphics, audio data and video clips are incorporated into HTML pages. The information is provided by servers of which a server SRV is represented in FIG. 1 by way of example. The portal www.web.de operated by the applicant is referred to as a possible application of such a server.

The users thus find the most varied web presences (websites) and internet pages (web pages) with all types of information, such as e.g. catalogue pages, webpages of enquiry services, travel services, search engine results etc., on the WWW. Advertising, in particular in the form of ad banners, often also accompanies the actual information. The actual information is preferably found on so-called contentservers. The ad banners can be stored there or on a separate server, the so-called adserver, wherein the adserver controls the appearance of the advertising in a targeted manner.

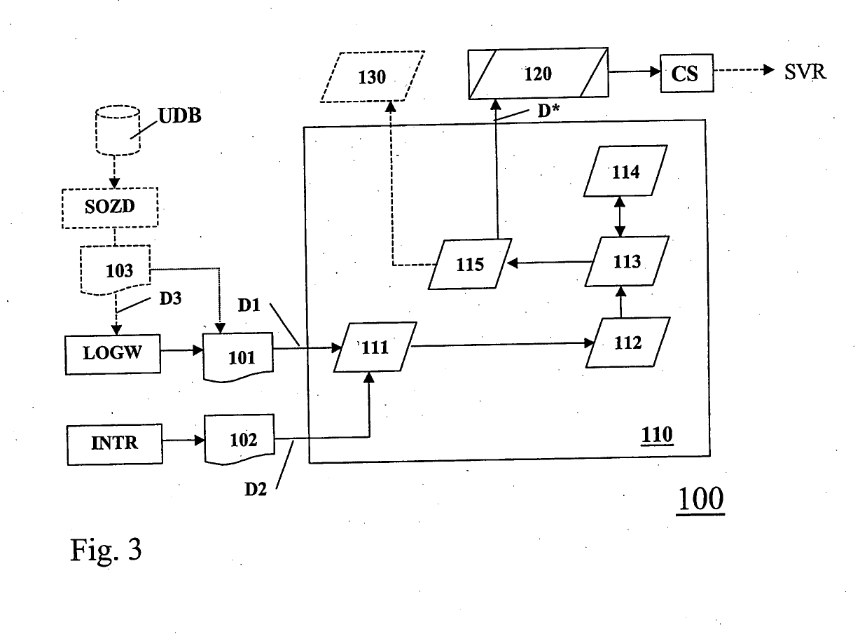

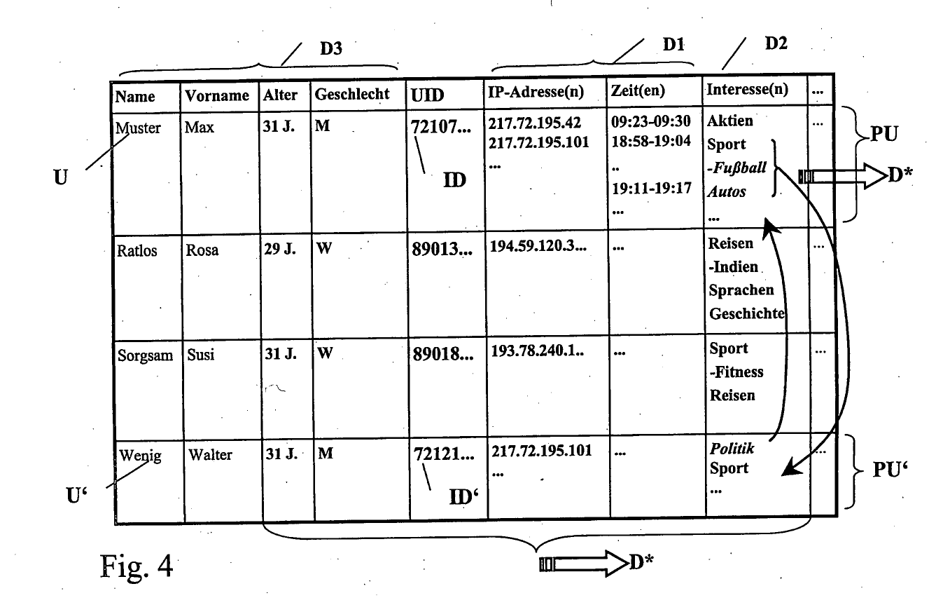

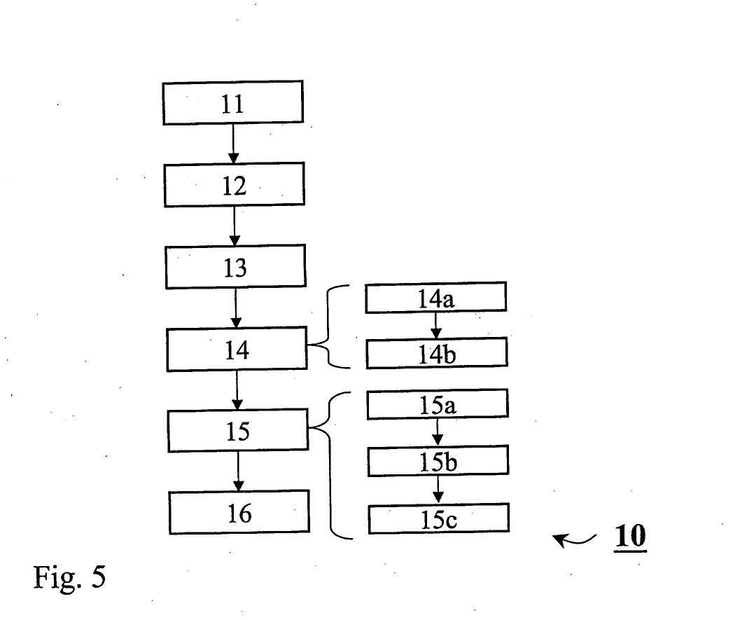

In FIG. 1 it is shown how a system 100 set up according to the invention to control the advertising is connected to a server SRV. The structure of the system itself is shown in FIG. 3. The method according to which the system operates is illustrated with the help of FIGS. 4 and 5.

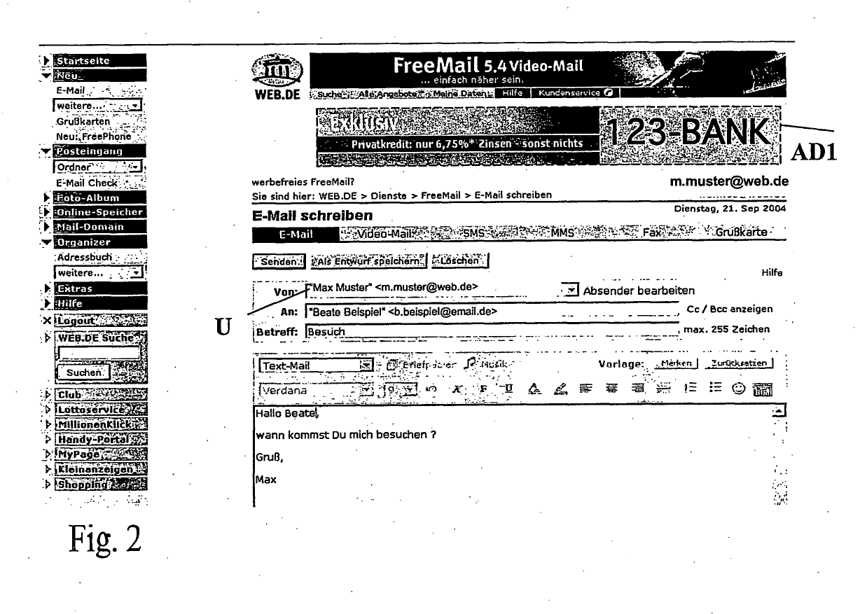

Before precisely describing these Figures, FIG. 2 will firstly be discussed here, which shows an application of an internet service specifically used by user U, namely the e-mail service www.freemail.de named at the outset. FIG. 2 is also to illustrate the inclusion of an ad banner AD1 corresponding to the invention:

In the example shown the user is called “Max Muster” and has set up an e-mail user account on the “FreeMail” service. His e-mail address is m.muster@web.de. As soon as Max Muster visits the website of the “FreeMail” e-mail service via a browser and logs in there, he sees the application represented in FIG. 2 with the actual operating and information fields. These include essentially the menu bar (left), the header line with the logo of the service provider (top right) and the input and reading areas for e-mails (middle to bottom, right). The user U also sees an advertising field into which the service provider inserts ad banners, here banner AD1. This is then automatically inserted by the system according to the invention and according to the proposed method for controlling the advertising.

In the example shown here the evaluation of the data and the control of the advertising result in an ad banner AD1 with an advertisement for a financial institution called “123 Bank” being shown to the user “Max Muster”. By evaluating the data within the method according to the invention a user profile has actually been prepared, according to which user U has a particular interest in financial services, especially information about shares (cf. FIG. 4). Therefore control data are generated by the system for the adserver which result in the precisely targeted insertion of the banner AD1. This advertisement specifically tailored to the user is very efficient because it is geared to the user's sociodemographic background (data D3) and the interests sought by him (data D2).

To further illustrate the invention, the sequence of the method and the structure of the system set up according to same are described in detail with the help of FIGS. 3-5:

Represented in FIG. 3 as preferred embodiment example is a system 100 which has several system components, such as a data-processing device 110 which corresponds to a computer set up as a profiler, and a control device 120 connected to same which corresponds to a computer set up as adserver, which controls a computer set up as contentserver CS and supplies it with forms of advertising in order to integrate the advertising in a user-related and targeted manner in the form of ad banners into the webpages displayed to the user. This also optionally occurs by controlling further servers (cf. FIG. 1 “SRV”).

To control the advertisement the data-processing device (profiler) 110 firstly evaluates various input data D1, D2 and D3 and prepares for the respective user a user profile which is prepared in the form of control data D* for the control device (adserver or adservercontrol) 120. The user profiles are managed anonymously. The profiler 110 determines for every user a user identification (user identity UID) to which the respective user profile is then also allocated. The UID is a code generated by pseudo-random generator (anonymous password), which is anonymous. References such as surname and first name of the user are discarded, so that all user-specific data are dealt with in the profiler 110 only under the respective UID which represents an anonymous identification for external systems. Thus the identity of the user cannot be discovered using the control data D* generated by the profiler. The identity of the user remains anonymous, yet the user profile permits an accurate control of the advertising tailored to the respective user.

In order that the profiler 110 can prepare particularly good user profiles it evaluates different types of input data D1, D2 and D3 which are obtained from the following data sources:

A first device LOGW, which corresponds to a so-called logwriter and which reports users' online accesses, records first data records 101 in the form of so-called logfiles. The data D1 contained therein essentially comprise details about the access behaviour of the individual users, in particular data such as access times, URL, page allocation etc. (also see FIG. 4).

A second device INTR, which in this example corresponds to an online survey device, records sets of survey records 102 with details about users' interests. Data D2 which reproduce selected preferred subject categories from various fields of interest are thus recorded by online questionnaires and prepared for the profilers (also see FIG. 4). User U is interested e.g. in shares, sport, in particular football, and cars. Another user is interested in travel, in particular travel to India, and languages as well as history etc.

In addition to these two sets of input data D1 and D2 other data D3 are also evaluated which are personal data in the narrower sense. These data D3 come from the user database UDB of a service provider system SOZD and are made available as data records 103 which are actually used for user administration of the offered service (e.g. e-mail service). Essentially, these data D3 are details about the name (optionally including first names), age and sex of the respective service user. Within the framework of the method and system proposed here at least the data regarding age, sex and postcode are processed. Further data can be added. The number of these service users (i.e. all e-mail users) is smaller than the number of all the WWW users considered here. However, by taking into account and evaluating the data D3 very valuable knowledge can be obtained which clearly also increases the accuracy of the advertising for all WWW users. This is described below in even more detail with reference to FIGS. 3 to 5:

The profiler 110 processes the data D1 to D3 according to the method 10 represented in FIG. 5, wherein a user identification is initially issued in a first step 11 for every user (see FIG. 4 “UID” field). In a second step 12 the first data D1 are recorded, i.e. the access data obtained from the logfiles, such as e.g. access times, URL, page allocation or even IP address etc. In a next step 13 the second data D2, i.e. the above-mentioned survey data which detail the preferred interests of the user, are recorded. As third step 14 the data D1 are supplemented by the above-named third data D3 if these data, in particular age and sex, are available. In the example shown the personal data D3 are incorporated into the logfiles of the users and are thus also taken into account with the data D1.

All the input data then pass through within the profiler 110 a data preparation step 111 which is formed as a log processor. The input data are filtered and optionally decrypted there. There is then a pre-aggregation in a step 112 (also called PFF component) and optionally a further filtering of the data. In a downstream step 113 and in cooperation with the core component of the profiler, namely with the profile forming step 114, data are generated therefrom in a compressed data format, namely in the so-called TAB delimited ASCII format, which already reproduce the desired user profiles. The user profiles are then transferred via a profile preparation step 115 (also called DB builder) in the form of control data D* to the adserver 120. The data can also be passed on to an analysis stage 130 (also called analysis DB) which analyzes and optionally documents the profiling process for system maintenance purposes and optimization purposes.

The method 10 and the system 110 operating according to same are furthermore designed such that the prepared user profiles are compared with one another and checked for completeness and commonality of the data by means of checking criteria (step 15b). Any incomplete user profiles are thereby recognized and then supplemented with data from complete user profiles. Thus if i.e. a user profile which has sufficient commonality, determined by the checking criteria, with another user profile is incomplete then it is completed with data from the other user profile (step 15c). This has the great advantage that even with a possibly small database the control of the advertising is highly accurate in qualitative terms. In this connection the sociodemographic data D3, for which a small database is more likely to be expected—not all WWW users are also simultaneously service users (here e.g. users of the e-mail service) are particularly to be seen.

With the help of FIG. 4 it is shown by way of example how individual incomplete user profiles can be supplemented:

The user profile PU has been calculated for the user U, and shows i.a. that he is 31 years old and male, and is interested in shares, sport, in particular football, and cars. By comparing this with other profiles the system recognizes that there is a similar user profile PU′ which has been calculated for another user U′. This user U′ is also 31 years old and male. Therefore the system compares the two profiles PU and PU′ in even more detail and finds that there is at least one common interest, namely “sport”. The system now carries out a data reconciliation under data D2, whereby it is now also assumed for the user U that, jut like user U′, he is interested in politics. In the reverse case it is assumed that user U′ is as interested as user U in football and cars. Both profiles PU and PU′ have been supplemented and improved by these measures which in turn increases the possibilities for accurate targeted appeals to users U and U′. Control data D* are then generated for the adserver from the respective profile for the adserver under the corresponding identification UID.

As can be seen from FIG. 4 a relatively small database offers a large variety of possibilities for effectively evaluating the user profiles for controlling advertising. For example it can also be established via data D1 when the user is particularly receptive to which field of interest. Using the example of the user U it is seen that he prefers looking at websites on the subject of shares in the morning and not finding out about sport and cars until the evening. Thus for this user the system will preferably connect to advertisements for financial services and the like in the morning (see banner AD1 in FIG. 2). But in the evening the system will preferably supply user U with advertisements about sport and/or cars. The affinity for online advertising is thereby further increased by these and similar measures.

The method described here can also be modified so that it extracts group data from the user profiles and combines them into a group profile, wherein the user identities allocated to the users are discarded. Thus the advertising is less directed towards individual users than towards typical user groups, such as e.g. the young singles group, families, sports enthusiasts etc. This type of targeted advertising makes sense particularly if group-specific events and offers are to be advertised (singles parties, family days etc.). The system can supplement the advertising with yet more details about the respective group, such as e.g. the number of group members: “Singles party on 22^{nd} Dec. in Treffdorf—212 singles from your region are invited—why don't you come too?”. In all cases the individual user remains anonymous and yet is addressed in a targeted manner.

### Further Description for the Preferred Implementations of the Invention

The following supplements the above description of the method and system for the targeting of advertising:

A better placement of advertising of all types in information networks is achieved by the invention. Advertising via banners on the Worldwide Web is to be named here as a preferred example of use.

The data relating to the user are recorded anonymously and taken into account when placing banners. To improve the available data a profiler is used which on the basis of detailed knowledge about the individual users permits conclusions to be drawn as to all users. The control data are provided via an API (Application Programming Interface) in the adserver and are preferably completely embedded in existing infrastructures. In particular a connection of external components to the adserver (Callout) is implemented and the necessary input data (input parameters) are made available as a logfile. The actual input data can thus come either direct from the logfile or also from a file prepared specially from the logfile.

The following main components and functions are provided to implement the system:

| Component | See | Function(s) |
|---|---|---|
| Contentserver | FIG. 4 “CS” | Supplies the information (content) - in particular for |
| | | parameterization of the SZM tags |
| SZM box unit | | Counts page impressions according to the AGOF |
| | part in | standard |
| | “LOGW” | |
| Loghost unit | FIG. 3 “101” | Accesses the log stream of the SZM box and writes in |
| | | files |
| Log processor unit | FIG. 3 “111” | Transforms the logfiles of the loghost specifically for |
| | | the decrypting of user-specific data (age, sex, . . . ) |
| PFF component | FIG. 3 “112” | Prepares and filters log data which are provided by the |
| | | log processor (parsing, filtering, feeding) |
| Profiling step unit | FIG. 3 “114” | Forms profiles - makes the profiles available to the |
| | | DB builder |
| DB builder unit | FIG. 3 “115” | Forms profile DBs from the profiler's data - makes |
| | | the DB available to the adserver |
| Adserver | FIG. 3 “120” | Acts as server for supplying forms of advertising - |
| | | accesses the profile DBs generated by the DB builder |

Regarding the Function of the Contentserver:

To make available all necessary information to the external components the conventional logfile from the SZM box is expanded to include various data (general information about the SZM box and SZM tags is found under http://www.infonline.de/support/szm.htm). Firstly the user identification present in the cookie (UID) is handed over to the SZM box request. Upon generating the SZM tags the adclient will read this information from the cookie and attach it to the request as a parameter. This is achieved during the upcoming rewriting of the adclient.

Secondly the user data are attached once to the SZM tag as a parameter when a user logs on to a service (such as e.g. www.freemail.de). As these are the user's personal data they are encrypted and thereby available in the logfile only encrypted. In order that the algorithm used for this cannot be passed to any external institution, in particular advertising partners, and to guard against data misuse, before the transfer of the logfile to the external component(s) the data are decrypted. The data are encrypted symmetrically e.g.
a) &pg=m&pa=32&pp=D_{—}76131&pn=3A

with the COPS classic command crypt and as a further key value pair attached to the variable
b) c_agof_var.

Note: “COPS” is a CM technology developed by Cinetic (www.cinectic.de) of a “corporate online publishing system” in which basically all the information is encapsulated in databases. This gives the user the possibility of using the prepared content many times over, in particular the same content on different platforms (multisite), but to maintain the content itself centrally in one place. However, COPS is not only the platform for pure content management (CM), but also an application server, whereby a scalability and performance is achieved.

In order to make these data available to the PFF component in unencrypted form a python program is used which parses the logfiles and decrypts the data (see also under the section “log processor”).

Regarding the Recording of the Survey Data:

A questionnaire is supplied via the adserver. The results are summarized in the formats CSV, SPSS, or fixed-length ASCII format.

Each question relates to a type of question whose result is presented in the results file. The UID is forwarded as a query parameter in the following form:
a) http:// . . . /polling?p0=UID

Further parameters can be forwarded to the variables p0-p9 reserved for same. These variables are then mapped to question types so that the UID is reproduced in the results file.

Regarding the SZM Box:

The SZM box is a unit/component for counting page impressions. The log stream of the box can be accessed via port 9000/9001 and used for one's own analyses. Two SZM boxes are preferably used and the availability of both boxes ensured via failover.

The following applies for the log stream structure: The data-record separator is <NEWLINE> and the data-field separator is <TAB>. The files contain one hour's logdata. The file name contains the data and the time of the log rotation.

Description of the fields:

| Description | Format | Example |
|---|---|---|
| Entry ID | Integer | 667045 |
| Time | Time | 999526997 |
| Client-IP | xxx.xxx.xxx.xxx | 212.18.195.222 |
| Forwarded | xxx.xxx.xxx.xxx | 212.18.195.222 |
| for | | |
| Cookie flags | N\|R [!] | R |
| Offer name | [Angebot].ivwbox.de | spring.ivwbox.de |
| Cookie | String | 3e22b68fa3b4675c0ddc7ddb8a261d32- |
| content | | 1089120173 |
| Parse code | OK\|E[1\|2\|3\|4\|5\|6\|7] | OK |
| Requested | URI (string) | /cgi-bin/ivw/CP/97;sc=freemail/content&pg=m&pa=32&pp=D76131?i=62.153.136.122&r=undefined |
| URL | | |
| User Agent | String | Mozilla/4.0 (compatible; MSIE 6.0; |
| | | Windows) |
| Referrer | URL (string) | http://www.angebot.de/saarlouis/index.htm |
| Checksum | String | 885cb4af80b931de257104f66ccce8e3 |

The “cookie flags” are as follows:
a) N=New Cookie, R=Returned Cookie, !=Reload

The parse codes are as follows:

| Parse code | Description |
|---|---|
| OK | OK |
| E1 | The request could not be completely parsed |
| E2 | The URL does not correspond to the required structure |
| E3 | The type of pixel requested does not correspond to the |
| | requirements <CP\|AP> |
| E4 | The cookie could not be parsed |
| E5 | The useragent in the request is not valid |
| E6 | The referrer in the request is not valid for this offer |
| E7 | No configuration for this host |
| E8 | No valid domain in the request |
| E9 | Unknown error |

Resolution of the “Requested Url”:

Within the Requested Url is located, in addition to a so-called AGOF-Code, a variable portion. Within the variable portion are found freely-definable key value pairs which can vary in order and number.

The syntax for the “Requested Url” is the following: /cgi-bin/ivw/CP/[Web.de-AGOF-Code][variable portion]?i=[User IP]&r=[referrer]. As a rule the referrer is “undefined”.

The syntax for “variable portion:” is as follows:

a) sc=[ZMOD-Code]&uq=[UID]&pa=[age to 2 digits (1-99)]&pg=[sex]&pp=[country(3 characters), post code(5 digits)]&pn=[Nielsen area(2 digits)

```
a) sc=[ZMOD-Code]&uq=[UID]&pa=[age to 2 digits (1-
  99)]&pg=[sex]&pp=[country(3 characters), post
  code(5 digits)]&pn=[Nielsen area(2 digits)
```

Here is an Example of a Logfile Extract:

24815344 1090390984 217.72.200.18 62.153.136.122 R
webdessl.ivwbox.de 002c40fe02dfd7d0 OK /cgi-
bin/ivw/CP/97;sc=freemail/content&uq=
3e22b68fa3b4675c0ddc7ddb8a261d32-1089120173&pa=32&pg=m&pp=
D_76135&pn=3B?i=62.153.136.122&r=undefined
Mozilla/4.0 (compatible; MSIE 6.0; Windows NT 5.0)
https://freemailng9901.web.de/online/folder/display.htm
8b37d8a1d0dcd5f4c8e4abd84d32798f

Regarding the User Identification UID:

The user identification (UID) can assume the following 2 formats:

Internal services:

3e22b68fa3b4675c0ddc7ddb8a261d32-108920173

External services:

ac140269-25820-1090511593-1

Regarding the Log Host:

The loghost accesses the log stream of the log processor on port 9000/9001 and stores the data on hard disk. The availability of the loghost and the provision of the data is guaranteed by the following measures:

Loss of an SZM box and takeover of the second, is taken into account by the ports of both boxes

The loghost is self-monitoring and re-starts itself

The status information of the loghost is incorporated in the NOC monitoring

The rotation of the logs is controlled when exceeding a configurable number of log lines or a period of time.

Regarding the Log Processor:

The log processor is preferably a python program and takes the log data from the log host, adjusts them and makes them available to the PFF component. This means specifically:

Encrypted demographic data (D3) such as age, sex etc. are decrypted

The following key value pairs are removed if the value ranges are not observed
a) Age: value between 1 and 99
b) Sex: “m” (male) or “f” (female) single-character
c) Postcode: 3-digit country code and a 3-digit post code number code (further combinations are adapted) [a-zA-Z_{—}]{3} [0-9] {5}
d) Nielsen: the following values are possible (1, 2, 3A, 3B, 4, 5, 6, 7)

The log processor takes the log files from the log host. The transferred files are deleted on the log host after being transferred onto the log processor.

The log host stores the adjusted log files for a maximum of n days.

The log host makes available the log files of the PFF component via a mountpoint (see in FIG. 3 transfer from “101” to “111” and “112”). The PFF component deletes the processed data from the log host.

Adjusting the Survey Data:

The data D3 gathered e.g. from questionnaires are checked and provided with headers in a tab-delimited ASCII file.

The following adjustments are to be carried out:
ZERO values are shown by an empty string in the export file
surplus tabs are removed
The data record with the UID “$cookie.UID$” is removed
Multiple surveys are filtered out or the PFF component repeatedly overwrites the record
Post code PLZ and country in separate fields
0 servers as “not occupied”

Regarding the DB Builder:

From the extracts generated by the profiler/LDAP system the DB builder prepares a file, readable by the adserver, which is distributed on the adserver, specifically:

Conversion of the files prepared by the profiler/LDAP-System from a TAB-delimited ASCII format into a compressed format defined by the system operator.

Distribution of the files on the 3 adservers

The DB dump prepared by the profiler/LDAP system is made available to the DB builder on a defined mountpoint.

Regarding the Adserver:

The adserver possesses so-called callouts, within which program expansions can be defined. With every request the UID with which the profile information is taken from the database provided by the DB builder is ascertained. The attributes supplied by the services are expanded by this profile information. In any follow-up processes it is transparent to the adservers and ultimately also to the user from where the segmentation variables come. Thus in the same manner an order targeting can be carried out on the data supplied by the services or by the profiler.

Tests thus far have shown that the overall performance of the adserver can decline if the latency time of the access to external resources increases. Therefore the latency time of the access to the external database is kept below 2 ms if at all possible. With longer response times the request process is to be aborted so that the required profile information is not available to the targeting (timeout). In addition, access to the database can be prevented for each configuration so that there are no negative effects on the overall performance. Furthermore each access to the database (defined by the system operator) can have a timeout attached to it so that the response times do not exceed a maximum. Additionally a request timeout can be defined within the adclient, which further increases the reliability and security of the system.

Outlining the Procedure:

The external database preferably prepared by the system operator is a simple DB file system in which key value pairs are stored. In this case the UID is the key and the profile information the value. The value does not have a structure predefined by the Berkeley DB, so that the structure is determined by the application. The use of the compressed format for the data means that a significant memory space is not occupied within the adserver process. Moreover, all the compressed data can be stored in the main memory of the adserver process.

The high performance will be achieved by the file system cache which cached the most-recently required blocks. Within a user session the required data are thus run mainly from this cache.

In order to optimize the incorporation of the external components, the following measures are also proposed:

Integration into the adserver can be turned on and off for each configuration

there is a timeout that can be configured from outside, according to how much time the external component may require at most for its response

The adservers are decoupled from the LDAP servers by the local databases. A loss of the LDAP server does not affect the supply behaviour of the adserver.

Regarding the Processing of the Log Files:

Should problems occur when processing the log files (log stream cannot be accessed from the box, logfile defective, loss of the computer and connected loss of loglines, etc.) this does not adversely affect the profile available as, viewed statistically, an individual log file is not relevant for the preparation of the profiles.

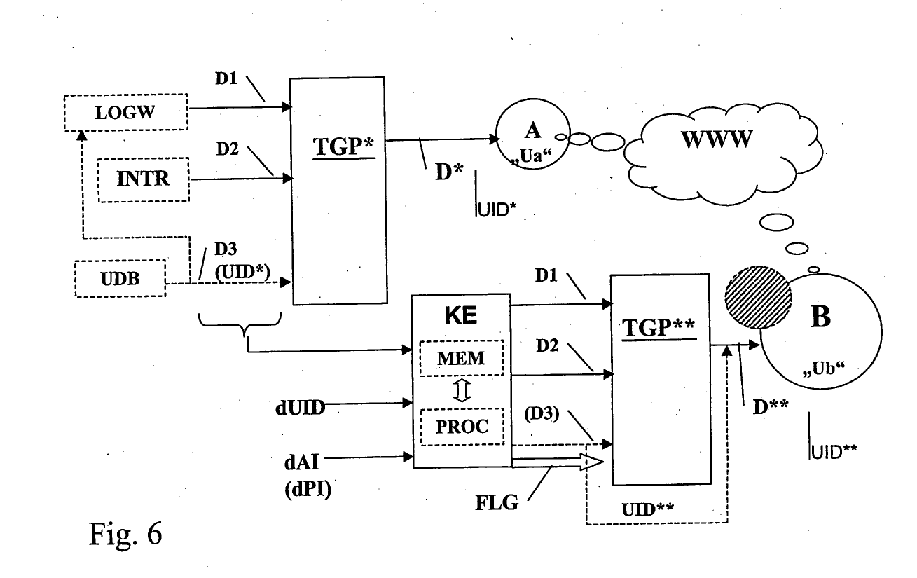

Regarding the Extension of Expanding the Reach (See in Particular FIGS. 6 to 9)

The examples shown here and described in more detail below are again based on the information network known as the “Worldwide Web”, WWW for short, i.e. the hypermedia system WWW established on the internet in which a uniform surface for representing information and interfaces for various internet services are made available. The users find on the WWW on many internet platforms the most different web presences (websites) and internet pages (webpages) with all types of information, such as e.g. also catalogue pages, internet pages of information services, travel services, search engine results etc. Advertising, in particular in the form of ad banners, often also accompanies the actual information. Each internet platform can thus be regarded as a media offer on which advertising is also carried, in order selectively target potential new customers from among the users.

FIG. 6 shows in a schematic representation the arrangement of two media offers A and B, which are also called offers A and B for short here and which are set up on the internet as websites. For each offer in each case a system TGP* or TGP** is used which essentially corresponds to the system shown in FIG. 3. However both systems TGP* and TGP** are now connected to each other or connected via a unit KE in order to optimally match the control of the advertising on both offers A and B to each other. The first offer A is e.g. the website of a well-known TV series www.gzsz.de which covers a usership Ua of several hundred thousand people. A first system TGP* is used to connect and place online advertising. This system TGP* achieves a targeted control of online advertising by recording specific data D1 to D3 and calculating control data D*, so this is very efficient. The connection of the advertising can be controlled such that the control data D* are generated depending on the user properties, here represented by the user identification UID*. In this way precise target groups can be defined and canvassed in targeted manner, wherein the user identifications UID* in the system are anonymized so that no direct conclusions can be drawn as to the identity of the respective user. The system TGP* can however e.g. establish that the respective user belongs to a specific age group and income bracket and is male. Thus the user can be allocated to a specific target group, e.g. “male, affluent seniors”. Such a target group is also called “WOOF” (acronym for “Well off older folks”) for short. The system TGP* prompts through the control data D* a supply, carried out by adserver, of the corresponding online advertising, i.e. e.g. advertising for exclusive cruises, for seniors wellness offers or also for andrologic medicines and preparations etc. However, this user will not receive “unsuitable” advertising, directed e.g. towards offers for family and children's holidays or hygiene articles for women or the like. A particular property of the system TGP* and also of the TGP** shown here is that targeted online advertising can be controlled depending on the user. To this end personal data D3 are also recorded and processed in conjunction with anonymized user identifications UID*.

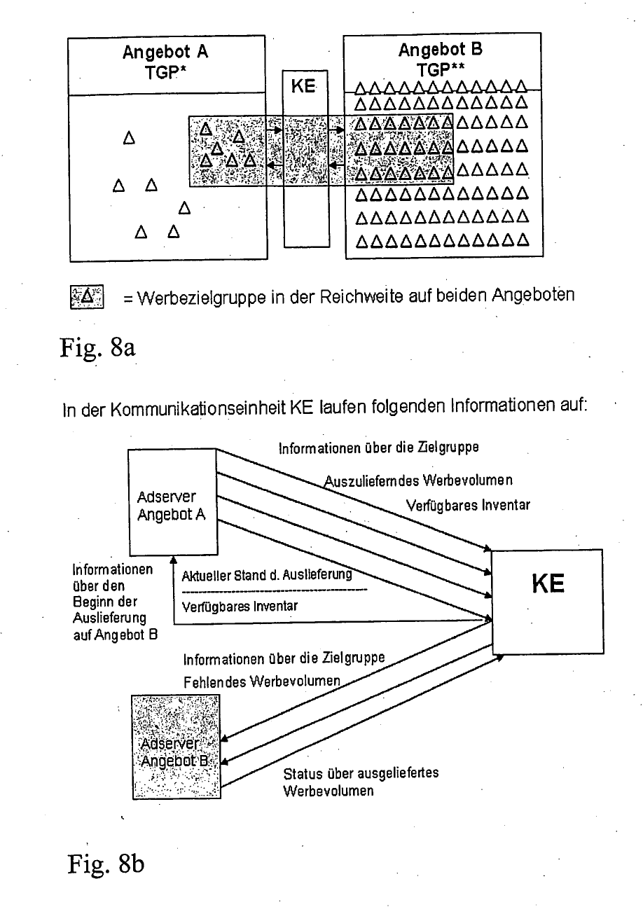

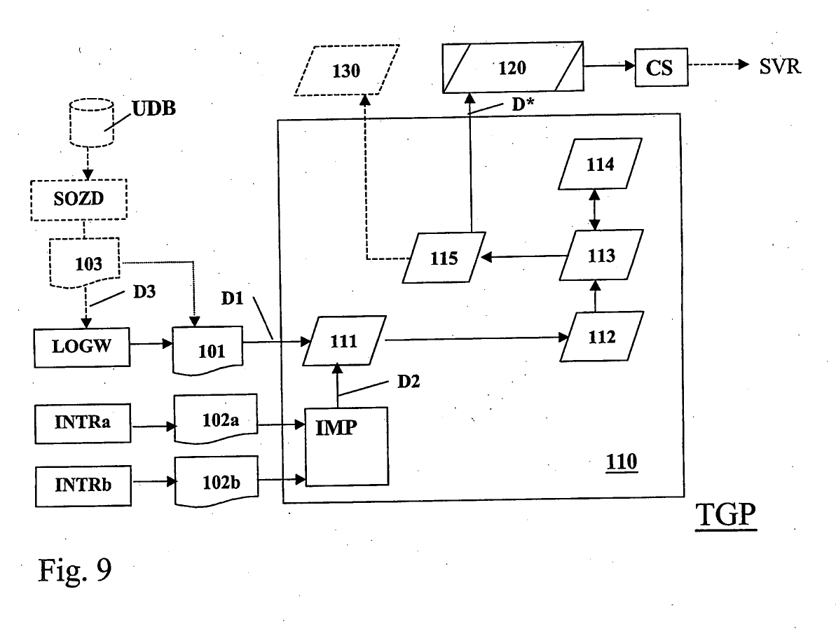

The precise structure and the function of one such system, here called TGP* or TGP**, is explained in detail with reference to FIGS. 8 and 9.

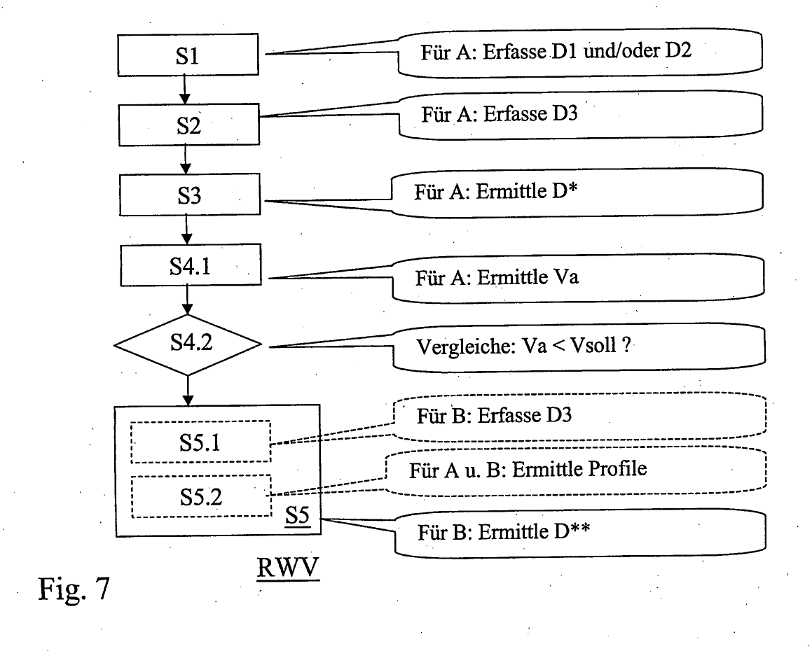

Here in FIGS. 6 and 7 the initial concern is the arrangement and cooperation of several of such systems using the example of the two shown systems TGP* and TGP** which respectively correspond substantially to the system according to FIG. 3. To this end a device KE is proposed here which is connected virtually as a communication unit between the systems TGP* and TGP** and which achieves a transparent and convergent extension of reach from the first media offer A to a second, larger, media offer B:

Starting from the usership Ua, reachable via the first offer A, which e.g. comprises a first reach of 500,000 users, this is to be extended to a planned reach of 4 million users. To this end the second offer B is to be used, which e.g. is the online portal www.web.de and which comprises a usership Ub of approx. 18 million users (unique users). As is shown by corresponding circles in FIG. 6, offer B is clearly larger than A, but an overlap of the two userships Ua and Ub can occur and should be taken into account when extending the reach.

The extension of reach is carried out essentially by the device KE which is also represented in FIG. 6 and which operates according to the method shown in FIG. 7. Therefore reference is made below to both FIGS. 6 and 7:

The device KE has almost the function of a communication unit which connects the two TGP systems to each other and thus fuses together and harmonizes the control of the online advertising on both platforms A and B. To this end the device KE essentially contains data-processing means PROC which are formed as a computer or processor, and data-storage means MEM connected thereto which comprise the actual work data store (RAM) for the processor and also the data memory for the intermediate storage of the useful data (hard drive or the like) and for the data management itself (database). The device KE supplies, under specific conditions, the input data D1 and D2 and optionally D3 for the second system TGP**, wherein it back-accesses the corresponding input data of the first system TGP* or evaluates and/or changes these. Thus the device KE controls the extension of reach.

As the flowchart in FIG. 7 shows within the framework of the process RWV for the extension of reach, steps S1 to S3 are carried out first, in which the first system TGP* records D1 and/or D2 and D3 at least from the input data and from these ascertains the control data D* for the first offer A. This function is described in even more detail in itself with reference to FIG. 9, which will be described later. As a result of the steps S1 to S3 shown here in FIG. 7 control data D* are generated by the system TGP* for the respective user under his anonymous identification UID* and supplied to the adserver (not shown) for offer A.

In order to decide about the extension of reach to offer B, in step S4.1 the device KE ascertains the advertising volume Va actually achieved in offer A and compares this in step 4.2 with a reference value Vsoll or threshold value which gives the desired or planned advertising volume. Several criteria or questions are reflected in this comparison, namely:
a) The question of whether the desired advertising volume Vsoll is not yet covered by the achieved advertising volume i.e.: Va<Vsoll?
   If YES then an extension of reach is generally advisable.
b) And if YES, then it is checked whether the residual volume not yet covered, i.e. the difference Vsoll−Va can already be completely covered by offer B, i.e. is the difference smaller than the potential usership Ub?
   If YES, then an extension of reach to offer B would suffice and further offers would not have to be considered.
b1) It is actually checked more precisely whether namely the usership actually achievable via offer B is sufficient to cover the residual volume. To this end the difference dUID is firstly ascertained (cf. FIG. 6), which states which users can be reached via offer B in addition to offer A, i.e. the size of the usership Ub—the overlap, with the usership Ua. The case could e.g. occur that Va=500,000 and Vsoll=4 million, i.e. the residual volume is 3.5 million and the usership Ub=3.8 million, so that offer B would be large enough. However there is an overlap of 400,000 of the userships Ub with Ua. The effective Ub, i.e. the usership actually achievable via offer B, is only 3.4 million, which would be too small to cover the residual volume. In this case it would have to be decided whether the extension of reach to offer B is large enough, because in total 3.9 million users would be effectively reachable in any case.
c) Further criteria are the so-called adimpressions AI or also pageimpressions, thus measures of the strength of an advertising campaign. It is e.g. checked whether the desired number of adimpressions AIsoll is already covered by the first offer A, so that no extension to the second offer B would actually be required. The same check can also be carried out for the pageimpressions PI. This means: Only if there is a difference between dAI and dPI which is greater than zero does extension to the second TGP system TGP** take place. These criteria AI and PI are evaluated simply by a statistical analysis of the current online advertising on offer A, which the first TGP system TGP* or the communication unit KE can carry out, and is then used as input valuable for the second TGP system TGP**. (see also FIG. 6).

The control of the advertising related to the respective user, wherein also in the second TGP system TGP** the first and second data D1 or D2 and preferably also the third data D3 are taken into account. The user identification UID** is used to recognize whether a user reached by the first system TGP* is already present or not. If the user identifications are the same in both systems (UID**=UID*), then the supply of the online advertising via the system TGP** to the second offer B can be prevented. To this end an identification is preferably entered into the control data D** such as e.g. an identity or flag. It is thereby achieved that the extension of reach is geared particularly towards the not yet recorded (new) usership, thus to the not yet reached part of the usership Ub.

As is also illustrated with reference to the FIGS. 8a and 8b, the reaches of a media offer A insufficiently available online can be transparently extended into the reach of another media offer B by the technology presented here. This possibility is particularly interesting in connection with a cross-media marketing of an offer. A further example of this: Advertising is to take place within the framework of a “TV/online” convergence campaign for the television series “GZSZ”, both on television and also on the internet on the website www.gzsz.de. However, as a “special interest site” this website has too little reach and access. The aim of the method presented here is to supplement the non-available online-media inventory on www.gzsz.de with convergent media capacity from another website (e.g. www.web.de) so that the advertising customer reaches the desired target group either on www.gzsz.de, i.e. on offer A, or also on the extension website www.web.de, i.e. offer B. Through the solution proposed here, the extension of reach takes place automatically and extrapolated in a measured way from the behaviour of the advertising on offer A (www.gzsz.de) to offer B (www.web.de).

To ensure the cross-media marketing of the whole offer A, it is necessary that an adequate marketable online potential is available from the start. The “convergent extension of reach” solution presented here provides that from the start, with the help of TGP systems, offer A is given an adequate or at least expandable reach for the marketing in the online sector by establishing a logical combination with an offer B. Thus, exploiting the control properties of the TGP systems, it is made possible for the first time for an offer A with an inadequate reach in the online medium and to convergently and automatically extend its target group, which offer A has sold to advertising customers, to offer B. Simultaneously the interaction of the advertising campaign with the offer A is analyzed and incorporated into the configuration of the extension. Thus there is also access online for marketing for corresponding target groups from the start of publication of offer A.

As is also presented using FIGS. 8a and 8b, the invention can be put into practice or realized in the following manner: In order to be able to extend the corresponding advertising-relevant target groups for offer A to an offer B with the TGP system, an extension of the TGP system to offer A is required, which makes possible communication on the basis of a defined set of variables between the two offers A & B.

To this end a system TGP* is used on offer A which records, analyzes and makes available according to the TGP system the corresponding target groups which are supplied by the adserver of offer A. The system TGP* on offer A supplies the advertising to the online offer of A with the help of the TGP analyses on the basis of logfiles, the on-site survey and the optionally present user information, through recording processes. Offer A defines the target group for the advertising customer and supplies this with the media-control system TGP* on its offer A. During the supply of the advertising to offer A a coupling process is initiated which takes place with a second online offer B on which the TGP system is likewise implemented, namely in the form of a second system TGP**. This coupling process is guaranteed by the communication unit KE.

In order to obtain the information for identifying the target group of the offer A on offer B, the data sources are harmonized in order to contain a common set of variables. Essential constituents of the set of variables is sociodemographic information such as e.g. age, sex, size of household, net household income etc. Thus the target groups of offer A can also be reproduced on offer B.

The coupling process between offer A and offer B within the framework of the TGP system now drives the advertising volume booked by a customer and ensures that this is also supplied in full.

This means that if the volume from offer A is exhausted, the rest is supplied to offer B until the advertising volume in the same advertising target group is finished.

The process taking place in the device KE or communication unit can be described essentially by the following steps a)-f):

The communication unit KE simultaneously receives the information about the target group from offer A and sends it to offer B if condition b). is satisfied;

If the advertising volume to be supplied on offer A is greater than the available inventory in the target group, the communication unit KE sends a request to the adserver of offer B and requests the inventory available there;

When condition b) applies the communication unit constantly obtains the information about the supplied advertising means in relation to its temporal course;

On the basis of this information the communication unit KE calculates the index for connecting the adserver of offer B;

If the threshold value is reached, the communication unit KE sends the information to the adserver of offer B and this begins to supply the missing advertising volume.

The adserver of offer B supplies the information about the start of the supply to the communication unit KE which in turn forwards this information to the adserver of offer A.

With the transparent extension of reach offer A has the possibility of extending its usership to offer B regardless of the condition of whether the comparable target group of offer A is sufficient. Corresponding advertising campaigns which then begin on offer A can thereby be transparently extended into the reach of offer B. There is also the option to combine this over several offers, in which the communication unit KE processes the corresponding information and then makes the offers available in processed form to the respective adserver.

FIG. 9, which shows in detail the structure of a TGP system, is discussed in more detail in the following (see TGP* and TGP** in FIG. 6). The TGP system shown here in FIG. 9 has several system components, namely a data-processing device 110 which corresponds to a computer set up as a profiler, and a control device 120 connected to same which corresponds to a computer set up as adserver, which controls a computer set up as contentserver CS and supplies it with advertising forms in order to integrate the advertisement in a user-related and targeted manner in the form of ad banners into the webpages displayed to the user. This occurs optionally also by controlling further servers, as is indicated by the arrow pointing to “SRV”.

The data-processing device (profiler) 110 records the various input data D1, D2 and D3 and evaluates them in order to prepare a user profile for the respective user and generate control data D* for the control device (adserver) 120 which supplies the online advertising in a targeted manner. The user profiles are managed anonymously. For every user the profiler 110 determines a user identification (user identity), to which the respective user profile is then also allocated. The user identification is a code generated by pseudo-random generator (anonymous identification), which is anonymous. References such as the surname and first name of the user are discarded, so that in the profiler 100 itself all the user-specific data are treated only under the respective user identification which represents an anonymous identification for external systems. Thus the identity of the user cannot be discovered even using the control data D* generated by the profiler (cf. user identifications UID* and UID** in FIG. 6). The identity of the user remains anonymous, yet the user profile permits an accurate control of the advertising tailored to the respective user.

In order that the profiler 110 can prepare particularly good user profiles it evaluates different types of input data D1, D2 and D3 which are obtained from the following data sources:

A first device LOGW, which corresponds to a so-called logwriter and which reports users' online accesses, records first data records 101 in the form of so-called logfiles. The data D1 contained therein essentially comprise details about the access behaviour of the individual users, in particular data such as access times, URL, page allocation etc.

Further devices INTRa and INTRb, which correspond to online survey devices, record, preferably via online questionnaires, details about users' interests which are present in corresponding sets of survey records 102a and 102b respectively. The data records are combined in an importer IMP to form data D2 and processed for the profiler. The data forward selected preferred subject categories from various fields of interest. One user is interested e.g. in shares, sport, in particular football, and cars. Another user is interested in travel, in particular travel to India, and in languages as well as history etc.

The second data D2 are actually ascertained by means of several online surveys. The data D2 go back to a first data record 102a and a second data record 102b which is ascertained by means of an online market research survey or by means of an offline target group survey. Data which are requested via different types of media such as print, TV and/or radio and can serve as informative reach extension studies because they reproduce comprehensive information about the usership of the respective media offers can also be acquired by this differentiated recording of data. This exploits the fact that every single media offer can describe its usership very precisely, but often there is no summary of the data.

In addition to the input data D1 and D2, other data D3 are also evaluated which are personal data in the narrower sense. These data D3 come from the user database UDB of a service-provider system SOZD and are made available as data records 103 which are used for user administration of the offered service (e.g. e-mail service). Essentially, these data D3 are details about the name (optionally with first name), age and sex of the respective service user. Within the framework of the method and system proposed here at least the data regarding age, sex and post code are processed. Further data can be added. The number of these service users (i.e. all e-mail users) is smaller than the number of all WWW users considered here. However, by taking into account and evaluating the data D3 very valuable knowledge can be obtained which clearly also increases the accuracy of the advertising also for all WWW users.

The profiler 110 processes the data D1 to D3 according to a special method, wherein a user identification is initially issued in a first step to every user. In a following step the first data D1 are recorded, i.e. the access data obtained from the logfiles, such as e.g. access times, URL, page allocation or even IP address etc. In a next step the second data D2, i.e. the above-mentioned survey data which detail the preferred interests of the user, are recorded. This step comprises several part-steps, namely the recording of survey data from a market inquiry or customer survey (part-step for ascertaining the data 102a) and the recording of survey data in the form of an online survey of customers or customer groups who are allocated to certain target groups (part-step for ascertaining data 102b). In the last partial step the survey data (102a and 102b) are combined (forming the data D2).

The data D1 are then supplemented by the above-named third data D3 if these data, in particular age and sex, are available. In the example shown the personal data D3 are incorporated into the logfiles of the users and are thus also taken into account with the data D1.

All the input data then pass through within the profiler 110 a data preparation step 111 which is formed as a log processor. The input data are filtered and optionally decrypted there. There is then a pre-aggregation in a step 112 (also called PFF component) and optionally a further filtering of the data. In a downstream step 113 and in cooperation with the core component of the profiler, namely with the profile-forming step 114, data are generated therefrom in a compressed data format, namely in the so-called TAB delimited ASCII format, which already reproduces the desired user profiles. The user profiles are then transferred via a profile preparation step 115 (also called DB builder) in the form of control data D* to the adserver 120. The data can also be passed on to an analysis stage 130 (also called analysis DB) which analyzes and optionally documents the profiling process for system maintenance purposes and optimization purposes.

The method and the TGP systems operating according to same are furthermore designed such that the prepared user profiles are compared with one another and checked for completeness and commonality of the data by means of checking criteria. Any incomplete user profiles are thereby recognized and then supplemented with data from complete user profiles. Thus if i.e. a user profile which has sufficient commonality, determined by the checking criteria, with another user profile is incomplete then it is completed with data from the other user profile. This has the great advantage that even with a possibly small database the control of the advertising is highly accurate in qualitative terms. In this connection the sociodemographic data D3, for which a small database is more likely to be expected—not all WWW users are also simultaneously service users (here e.g. users of the e-mail service) are particularly to be seen.

The method also make it possible to supplement individual incomplete user profiles with data from other, preferably complete user profiles if the profiles are similar to one another: E.g. an already produced user profile reveals that the user is 31 years old and male, and is interested in shares, sport, in particular football, and cars. By comparing this with other profiles the system recognizes that there is a similar user profile which is allocated to another user who is also 31 years old and male. The system then compares the two profiles in even more detail and establishes that there is at least one common interest, namely “sport”. The system now carries out a data reconciliation using data D2, whereby it is now also assumed for the other user that, just like the first user, he is interested in politics. In the reverse case it is assumed that to the other user that he, like the first user, is also interested in football and cars. Both profiles have been supplemented and improved by these measures which in turn increases the possibilities for accurate targeted appeals to users U and U′. Control data D* are then generated for the adserver by the respective profile under the corresponding identification UID.

Care is to be taken that the personal data D3 are preferably not processed under the generic user passwords which a user management of the service provider (e.g. the user management of the e-mail service) uses, but under a user identity (see UID* or UID** in FIG. 6) which is generated by the system proposed here specifically for the purpose of controlling of advertising, preferably by random generator as anonymous code, in order to prevent the data from being traced back to individuals. This anonymous code is stored e.g. in the form of a cookie on the user's PC, via which the user accesses the information network. Upon a later access by the user the anonymous code and the user profile allocated to him are recognized and used for targeting of the advertisement.

Care is also to be taken that the data recording of the input data is already carried out in a very targeted manner: In order to obtain the information regarding identification of the target group usership of the media offer, an online survey is carried out. This online survey ascertains the data user-specific for the media offer. Basic variables are i.a. age, sex, size of household, net household income etc. Using the data the corresponding targets are ascertained within the framework of the online survey in the method with the help of statistical methods (factor analysis, cluster analysis) and a recoding of the variables. Those who fall into the target group usership of the media offer are marked according to the default settings of the media offer in a newly generated variable. There is the possibility of dividing the target group usership of the media offer into further classes. This class information about the target group usership of the media offer is made available to the TGP media control technology in the data from the online survey. Within the framework of the TGP analysis method, the corresponding variable relating to the affiliation of the user of the online offer to the target group usership is relayed to the adserver.

With the method proposed here for the transparent extension of reach media offers have the possibility to extend their usership to an online offer, irrespective of the condition whether the comparable target group uses the media offer on the online offer. Corresponding advertising campaigns which run in the corresponding media offers can thereby be transparently extended in terms of reach.

The invention is not limited to the embodiment examples described here. Rather, other designs of the invention are also conceivable, especially also in the field of telecommunication, in particular in the field of mobile telephony where for example with the help of the invention advertising by SMS, MMS or banners in the browser window can be connected in a targeted way to the terminals (mobile phone, PDA) of the subscribers. The same also applies to advertising using sound pointers and/or audio messages on the telephones of subscribers, in particular in the field of telecommunication systems and call centre technologies.

### LIST OF REFERENCES

LOGW Recording means for online data (logwriter)
INTR Recording means for survey data from a market research survey (online and/or offline survey)
SOZD Recording means for offline data, in particular for sociodemographic data
100 System for controlling advertising in a communication network
101 Files with online data D1 (logfiles)
102 Files with survey data D2 (interrogative data)
103 Files with offline data D3 (sociodemographic data)
110 Device for ascertaining profile data (profiler)
111 Filter for the online data D1
112 Filter for the survey data D2
113 Filter for the offline data D3
115 Profiling means
116 Adaptation means for connecting an adserver
117 Driver for a data analysis program
118 Means for data extraction
120 Device for controlling and connecting advertising spaces (adserver)
130 Data analysis program
WWW Worldwide web on the internet
A First internet platform (offer A)
B Second internet platform (offer B)
TGP*, Systems for controlling online advertising on the first and second
TGP*** internet platform respectively
D*, D** Control data generated by the systems (TGP*, TGP**) for online advertising on the first and second internet platform respectively
KE Device (communication unit) for extending the reach of online advertising from the first internet platform (A) to the second internet platform (B)
D1, D2, D3 Input data for the systems TGP* and TGP** respectively, namely:
D1 First data with details about user access behaviour, in particular logfile data
D2 Second data with details about user interests, in particular survey data
D3 Third data with personal details, in particular age and sex
UDB User database for an online service
Ua, Ub Usership of the internet platform A and B respective
UID*, User identifications connected to or integrated in the control data D*
UID** and D** respectively
FLG Identification (symbol, flag) for identical or similar userships in the two internet platforms A and B
MEM Data memory
PROC Data-processing means
RWV Method of extending reach with the steps S1 to S5
TGP Further example of a system for controlling online advertising on the first and second internet platform respectively
INTRa Recording means for survey data from a market research survey (online)
INTRb Recording means for survey data from a customer survey in specific target groups (offline)

1-15. (canceled)

16. A method for controlling online advertising in an information network over which several users have access to information, comprising the following steps:
allocating a user identity to every user;
recording for every user first data containing details about the user's access behavior to the information;
recording second data for the respective user, the second data containing details about the user's interest in the type of information;
supplementing the first and/or second data by third data containing details about the identity of the respective user;
extracting control data for the respective user from the first, second and/or third data and transmitting the control data to a control device for controlling the advertising; and
storing at least the control data extracted for every user in a user profile under the allocated user identity.

17. The method according to claim 16 wherein the user profiles are compared with each other and completeness and commonality of the user profile data checked using predeterminable testing criteria.

18. The method according to claim 17 wherein an incomplete user profile which has a sufficient commonality, determined by the testing criteria, with another user profile is completed using the first, second and/or third data of the other user profile.

19. The method according to claim 16 wherein the extracted control data are used anonymously, the control data being managed in each case for every user under the relevant user identities, but without reference to a name of the individual user.

20. The method according to claim 19 wherein the third data contains the name of the individual user but is not referenced.

21. The method according to claim 16 wherein the third data contain personal details about the user including age and gender.

22. The method according to claim 16 wherein an online service offered by a service provider is used by at least a majority of the users over the information network; and the third data are called up from a database of the service provider.

23. The method according to claim 16 wherein the information network is the internet and the information the users access comprises visual information presented on internet pages; and in which the advertising is integrated as a banner into the presented information.

24. The method as recited in claim 23 wherein the information network is the world wide web.

25. The method as recited in claim 23 wherein the internet pages include portal pages, catalogue pages, internet pages from information services, travel services and/or search engine results.

26. The method according to claim 16 wherein group data are extracted from the user profiles and combined into a group profile and wherein the user identities allocated to the users are discarded.

27. The method according claim 16 in which to extend the reach of online advertising from a first internet platform having a first usership with a first reach to a second internet platform having a second usership with a second, larger reach, further comprising:
recording for the first usership the first and/or second data containing details about the users' access behavior or details about users' interests with regard to online information, and recording the third data;
for the first usership ascertaining first control data for online advertising on the first internet platform from the first, second and/or third data recorded; and
ascertaining a first advertising volume achieved by the online advertising on the first internet platform and comparing the first advertising volume with a planned advertising volume; and
if the first advertising volume is smaller than the planned advertising volume, ascertaining second control data for the online advertising on the second internet platform from the first and/or second data recorded for the first usership, wherein the third data containing personal details about the respective users are also recorded for the second usership, and ascertaining for both usership profiles commonalities and/or differences in order to gear the online advertising on the second internet platform to the profile of the first usership.

28. The method according to claim 27 wherein the third data is checked to determine whether within the second usership there are already users who also belong to the first usership, and wherein on the second internet platform the online advertising is connected there only for those users of the second usership who do not also belong to the first usership.

29. The method according to claim 27 wherein a user identity is allocated to every user in order to prepare the usership profiles having the commonalities and/or differences.

30. The method according to claim 27 wherein the online advertising is supplied user-related, and wherein an identifier is inserted into the second control data, the identifier being shown when a user of the second usership already also belongs to the first usership, and wherein the supply of the online advertising for these users via the second internet platform is then prevented.

31. The method according to claim 30 wherein the identifier is a display bit.

32. A device for controlling online advertising and for extending the reach of the online advertising from a first internet platform having a first usership with a first reach onto a second internet platform having a second usership with a second, larger reach, comprising:
data memory for data recorded for the first usership and including first and/or second data containing details about users' access behavior or details about users' interest regarding online information, and also including third data containing personal details about the respective users, in order to ascertain, from these data recorded for the first usership first control data for the online advertising on the first internet platform;
a data processor ascertaining a first advertising volume achieved by the online advertising on the first internet platform and comparing the achieved first advertising volume with a planned advertising volume, and establishing whether the achieved first advertising volume is smaller than the planned advertising volume, and then ascertaining, from the first and/or second data recorded for the first usership second control data for the online advertising on the second internet platform; and
a data recorder recording, for the second usership, the third data containing personal details about the respective users, and the data-processor ascertaining profiles for both userships having commonalities and/or differences in order to gear the online advertising on the second internet platform to the profile of the first usership.

33. A system for controlling online advertising in an information network via which several users have access to information, comprising:
a data processor allocating a user identity to every user and evaluating the first data which a first data device provides, the first data containing details about a user's access behavior to the information,
the data processor evaluating second data for the respective user provided by a second device, the second data containing details about the interests of the user in the type of information,
the data processor supplementing the first and/or second data with third data provided by a third device, the third data containing details about the identity of the respective user;
the data processor extracting control data for the respective user from the data and transmits them to a control device for controlling the advertising.

34. The system according to claim 33 wherein the information network is the internet, the information which the users access comprising visual information presented on internet pages, the data-processing device being a computer set up as a profiler storing at least the control data extracted for every user in a user profile under the user identity allocated to the user profile, and the control device being a further computer set up as an adserver controlling an additional computer set up as a contentserver integrating the advertising as ad banners into the presented information.

35. The system as recited in claim 34 wherein the information network is the world wide web.

36. The system as recited in claim 34 wherein the internet pages include portal pages, catalogue pages, internet pages from information services, travel services and/or search engine results.
